(19) United States
(12) Patent Application Publication
(10) Pub. No.: US 2015/0044981 A1
(43) Pub. Date: Feb. 12, 2015

(54) Multi-Notch Filter and Method for Multi-Notch Filtering

(71) Applicant: Yao H. Kuo, West Bloomfield, MI (US)

(72) Inventor: Yao H. Kuo, West Bloomfield, MI (US)

(21) Appl. No.: 13/964,935

(22) Filed: Aug. 12, 2013

(51) Int. Cl. H04B 1/10

(52) U.S. Cl. CPC H04B 1/1036; H04B 2001/1063
USPC 455/307

(57) ABSTRACT

A system and method for multi-notch filtering for a communication device are provided. The system includes an input node to receive a signal directed to the communication device; a time delay element to delay the signal by a predetermined time delay; a summation element to sum the signal and the time-delayed signal; and a gain element to output the summed signal to the communication device.

### BACKGROUND

Radio frequency (RF) filters are employed in numerous communication applications. For example, a RF filter may be employed to a selected band of frequencies for either a receiving of, or transmission of, various signals. Some example filters are high-pass, band-pass, notch, or a combination thereof. The various filters enumerated above may be implemented depending on the frequency components to be removed from the signal in question.

Specifically, the RE filter may be implemented in a vehicle. The vehicle may have a communication system equipped to receive radio signals, or other signals to aid in the operation of the vehicle.

However, due to the mobile nature of the vehicle, the vehicle may be situated in locations that make the vehicle privy to interference. The interference may be sourced from a variety of sources, including power lines, harmonic frequencies, motor noise, and the like.

In these situations, a filter may be employed to improve the integrity of the signal being received via the vehicle, and increase the overall quality of the communication system's operation.

### SUMMARY

A system and method for system and method for dynamically altering shared content are provided. The system includes a shared content receiver to receive raw shared content from the content sharing service; an identifier module to identify information about a visitor to the content sharing service receiving the shared content; an audio retriever to retrieve audio based on the identified information, and a shared content creator to create the shared content by overlaying the retrieved audio with the raw shared content.

### DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates an example of interference affecting a receiving source sourced from a signal generated by a transmission source.

FIGS. 2(a)-(c) illustrate an example of the signal being approximated to be viewed as a sinusoidal function.

FIG. 3 illustrates an example of a system for multi-notch filtering.

FIG. 4 illustrates an example of a method for multi-notch filtering.

FIG. 5 illustrates a simulation depicting the system of FIG. 3 and the method of FIG. 4.

FIG. 6 illustrates a multi-notch filter system according to another example embodiment.

FIG. 7 illustrates a simulation depicting the system of FIG. 6.

FIG. 8 illustrates a circuit diagram of an example multi-notch filter circuit according to the system described in FIG. 3.

FIG. 9 illustrates a circuit diagram of an example multi-notch filter circuit according to the system described in FIG. 6.

FIG. 10(a) illustrates an example implementation of several of systems in FIGS. 3 and 6 cascaded together.

FIG. 10(b) illustrates an example implementation of the microcontroller.

FIGS. 11(a) and 11(b) illustrate an example implementation of a combined multi-notch filter employing system in FIGS. 3 and 6.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The aspects disclosed herein are described more fully hereinafter with reference to the accompanying drawings, in which embodiments of the invention are shown. These aspects may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

Interference signals are linear in nature. Thus, when the interference signals are broadcast through space, the signals are received at an antenna as a linear function. Signals that go through space may be transmitted through various mediums, such as air, cable, trees, buildings, and the like.

As explained above, the interference signals may be created through the propagation of the signal from a transmitting source to a receiving source (i.e. a transmission device to a receiving device). During the propagation, the interference may accumulate through interactions with other signal generating sources, as enumerated above.

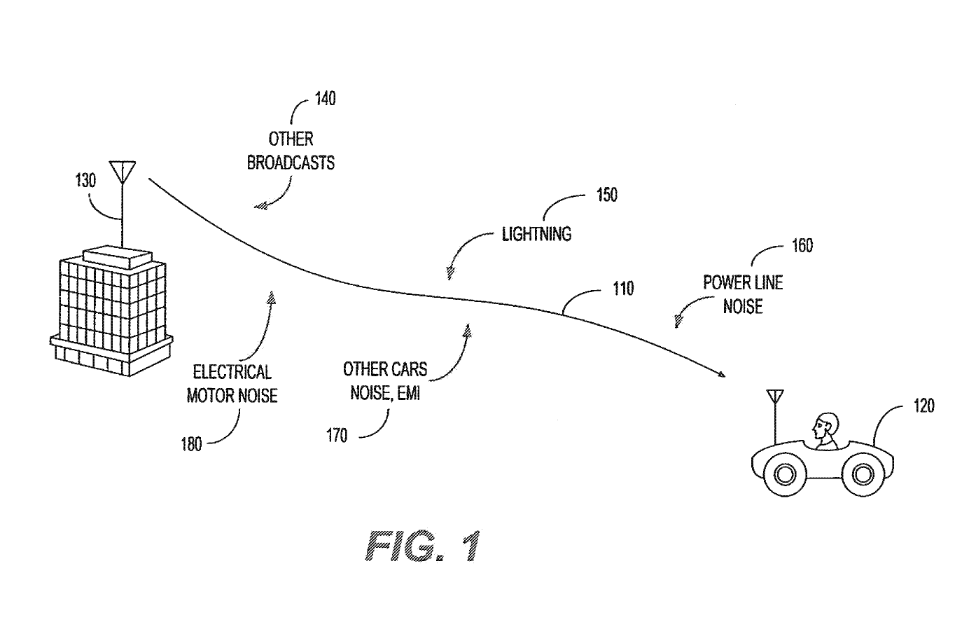

FIG. 1 illustrates an example of interference affecting a receiving source 120 sourced from a signal 110 generated by a transmission source 130. Referring to FIG. 1, the receiving source 120 is implemented along with a vehicle. However, one of ordinary skill in the art may implement the receiving source 120 in any communication system.

The signal 110 may run into various interference signals, such as other broadcasts 140, lightning 150, power line noise 160, other car noises 170, or electrical motor noise 180.

The signal 110's energy (E-d) may be linearly affected by the energy introduced by the interference signals. Due to the linear relationship between the signals, the various energies may be summed or subtracted to determine the total energy (E-Total). The various signals may be represented by the following energy totals: other broadcasts 140 (E-ud), lightning 150 (E-l), power line noise 160 (E-p), other car noises 170 (E-on), or electrical motor noise 180 (E-n). Thus, E-total may be characterized by the following relationship:

E-total=(E-d+E-ud+E-l+E-p+E-on)×(Antenna Efficiency), wherein the Antenna Efficiency is a measure of the efficiency with which a radio antenna converts the radio-frequency power accepted at its terminals into radiated power.

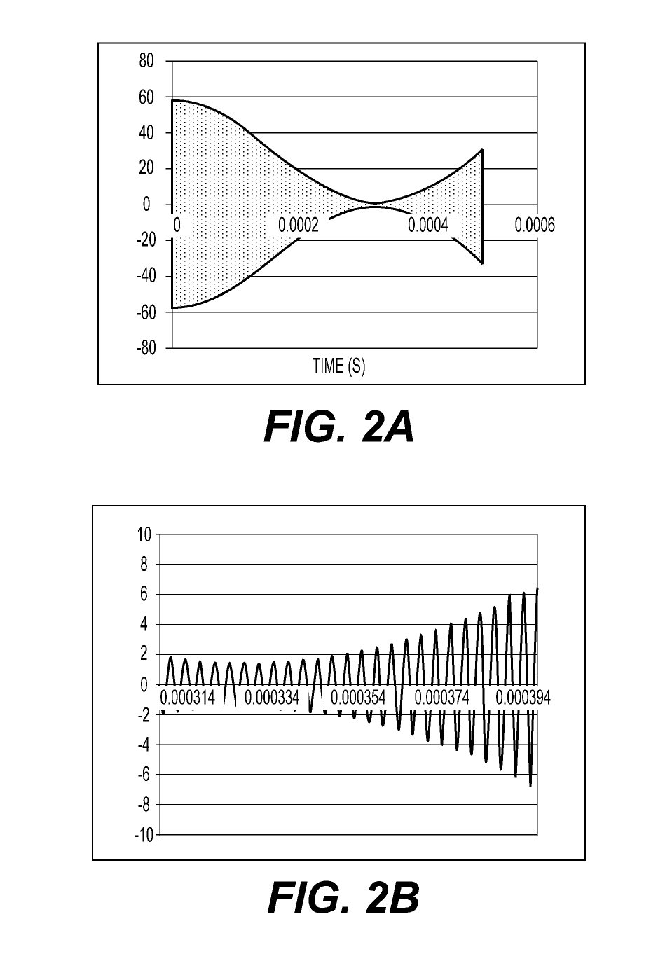

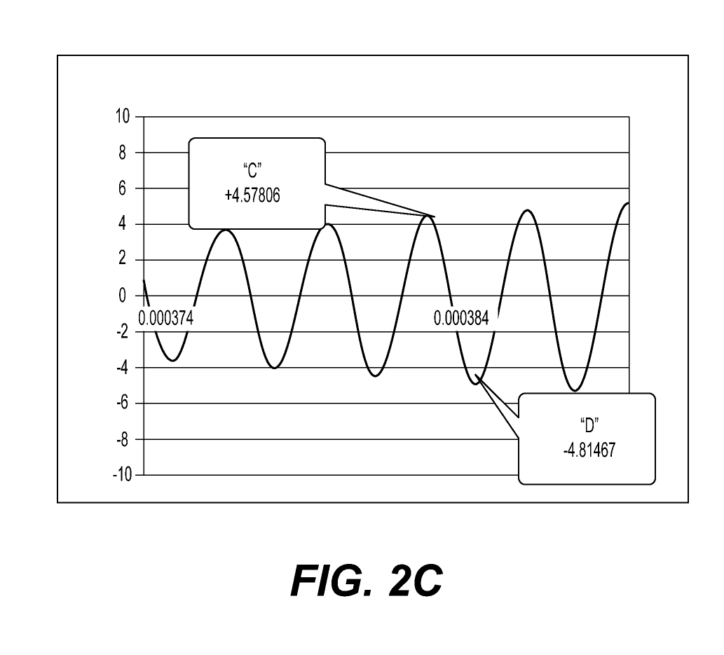

FIGS. 2(a)-(c) illustrate an example of the signal 100 being approximated to be viewed as a sinusoidal function. A general application of trigonometric functions is that sin(A) is the still the same frequency of sin(A+ or −nπ), wherein n is an integer.

Referring to FIGS. 2(a)-(c), an example is shown of a progression from a larger view of the signal to a zoomed in view. In FIG. 2(a), a zoomed out version of signal 110 is shown. In FIG. 2(b), a zoomed in, relative to the graph in FIG. 2(a) is shown of signal 110. In FIG. 2(c), a zoomed in, relative to the graph in FIG. 2(b) is shown of signal 110.

As shown in FIGS. 2(a)-(c), as the view of signal 110 becomes more granular, the nature of signal 110 becomes closer to a sinusoidal function. Thus, as shown in the FIG. 2(c), the difference between one upper cycle and a lower cycle is 0.24V (C−D). Thus, the error of 0.24V may be considered negligent relative to the voltage of an AM RF signal, such as signal 110 (which may be around 58V). The aspects disclosed herein rely on the above observation, that when zoomed in, the signal 110 significantly resembles a sinusoidal function.

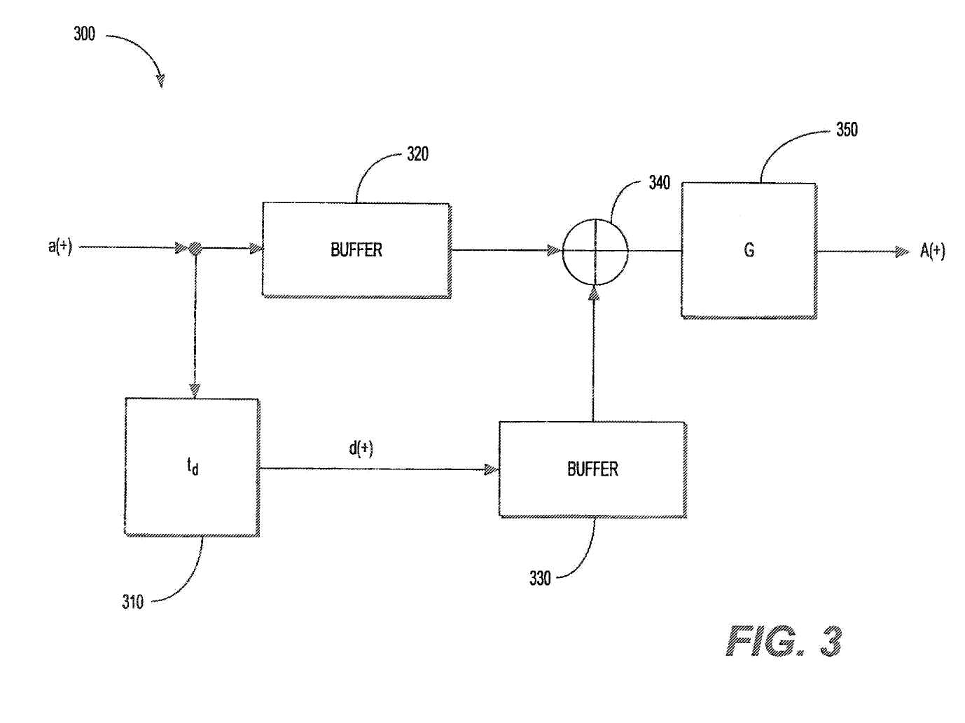

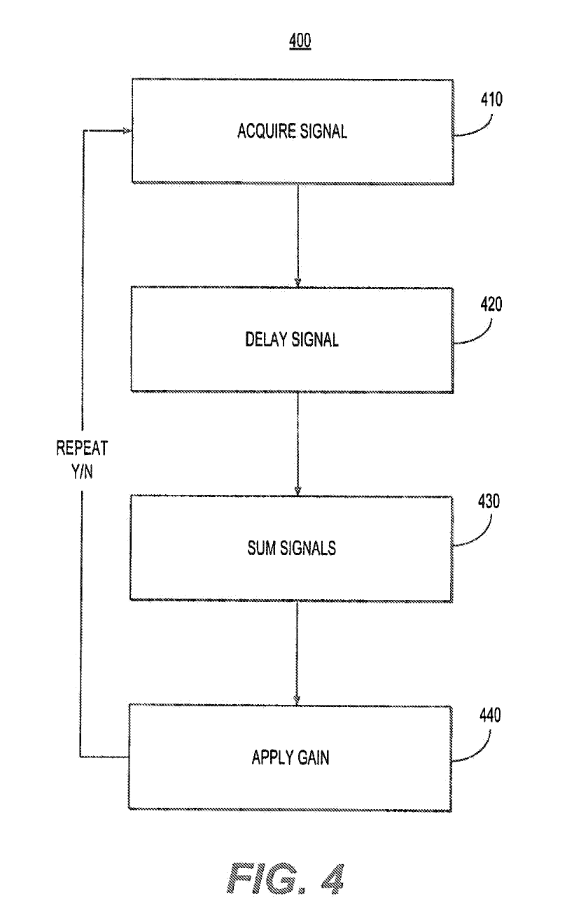

FIG. 3 illustrates a block diagram of a system 300 for multi-notch filter according to a first embodiment. FIG. 4 illustrates a method 400 for multi-notch filtering according the system in FIG. 3. The system 300 may be implemented in either circuit form, or via a processor incorporating digital signal processing (DSP). The various elements shown in system 300 may be implemented via software instructions, implemented by the DSP. For example, inverting signals, summing signals, the buffering functions and the like may be simulated through a DSP based on predetermined settings, and memory.

In operation 410, an input signal, such as signal 110 is received. As explained in FIG. 1, the signal 110 may be received via a receiving source 120, transmitted via a transmission source 130. For example, the signal 110 may be an AM transmission signal employed to deliver a radio signal to a car radio.

In operation 420, an input signal (such as signal 110) is delayed. For example, if the portion of the signal 110 is analyzed is 300 KHz, the delay may be a half cycle (π3=t-delay1=1.6667 us). The delay may be predetermined by the implementer of method 400.

In operation 430, the input signal (signal 110) and the delayed signal are summed. Essentially, the total becomes zero. In this way, the frequency of 300 KHz may be defined as being notched out. The following sum of the input signal and the delay signal may be expressed as:

$$\begin{matrix}E \text{-} out = sin ( 2 * π 3 * 300 kHz * t ) + \\ sin ( 2 * π 3 * 300 kHz * t - π ) \\ = sin ( 2 * π3 * 300 kHz * t ) - \\ sin ( 2 * π3 * 300 kHz * t ) \\ = 0\end{matrix}$$

Further, based on the above relationship, π3 is 2 times 600 KHz half cycle, 3 times 900 KHz's half cycle, 4 times 1200 KHz's half cycle, and so on. Thus, because of this relationship, the multi-notch filter eliminates all odd orders of harmonics of 300 KHz and doubles the amplitude of all even orders of harmonics of 300 KHz. The following relationship can be shown with the following relationship:

$$\begin{matrix}a ( t ) = \sum [ n = 0 to ∞ ] ( cos ( 2 * π * n * f * t ) ) \\ = 1 + cos ( 2 * π * f * t ) + cos ( 2 * π * 2 * f * t ) + … \\ cos ( 2 * π * n * f * t ) ;\end{matrix}$$

where

a(t) is the input signal and has a DC component of 0 Hz.

As described in operation 420, the first frequency is delayed by a half cycle, resulting in the following expression:

d(t)=Σ[n=0 ∞](cos(2*π*f*t−n*π)

When a(t) and d(t) are summed together, the notching occurs. As shown below, the resultant expression is that every even component of the a(t) is double, while the odd component of the a(t) is zeroed. The following expression describes A(t) (sum of a(t) and d(t)):

A(t)=2+2*cos(2*π*f*t)+2*cos(2*π*4*f*t)+ . . . +2*cos(2*π*m*f*t)

In operation 440, the output A(t) may undergo a gain stage. In the gain stage, the output may be multiplied by a predetermined gain amount (for example, 0.5), and thus be prepared for reception by a communication device.

The method 400 may be performed iteratively. The method 400 may be performed using different predetermined time delays for each iterative operation.

The system 300 illustrates an example implementation of the method 400 described above. The system 300 includes an input for the input signal 110, a delay block 310, buffers 320 and 330, a sum block 340, and a gain block 350. The buffers 320 and 330 ensure that the signals are propagated in a strong enough fashion to be summed by the sum block 340. The sum block 340 performs the operation of operation 430, while the delay block 310 performs the operation of operation 420. The gain block 350 ensures that the output signal is strong enough to be propagated to a following system, such as a communication system receiving the output. The gain stage may be 0.5, for example.

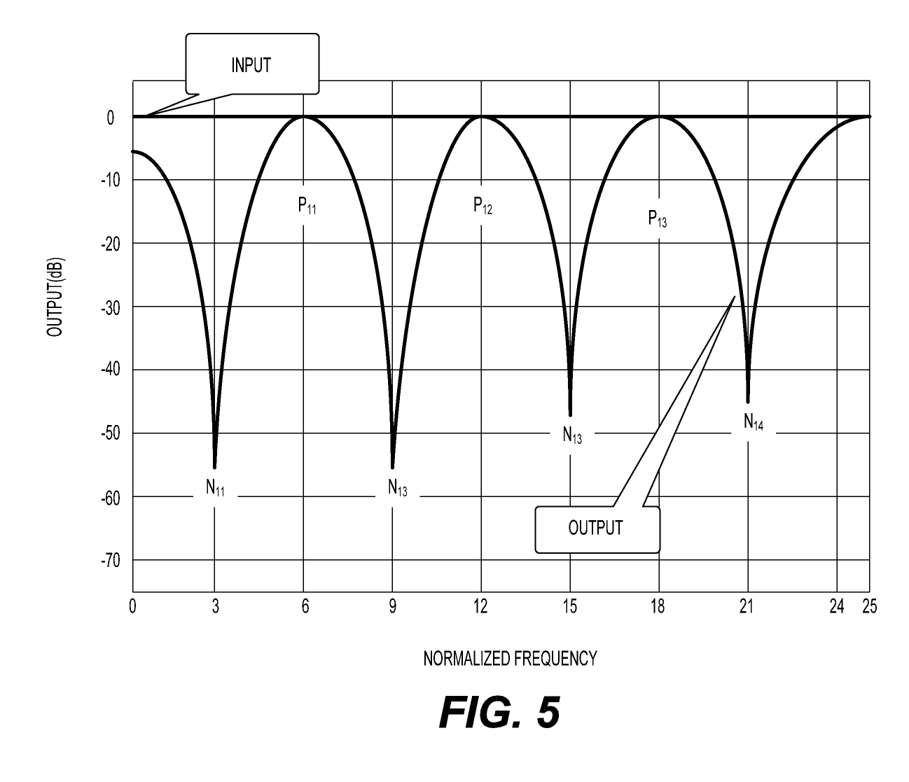

FIG. 5 illustrates a simulation depicting system 300 and method 400 with a sample signal 110. In the example shown, with an input signal of 600 KHz, the notched out signals are 300 KHz, 900 KHz, 1500 KHz, . . . and so on. As shown in FIG. 5, the frequency axis is normalized, and the amplitude axis is in decibels (dB).

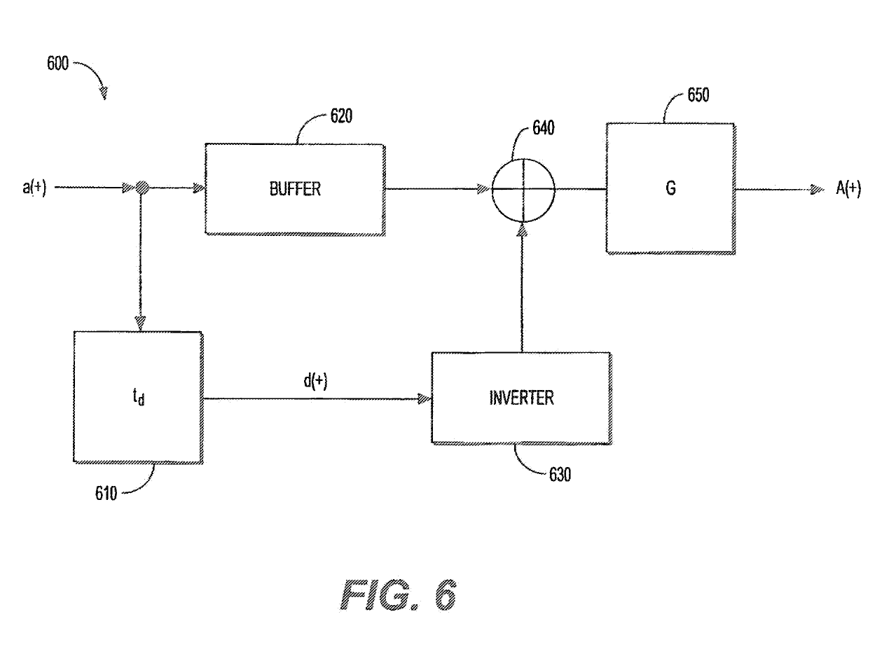

FIG. 6 illustrates a multi-notch filter system 600 according to another example embodiment. The system 600 includes a delay block 610, a buffer 620, an inverter 630, a sum block 640, and a gain block 650.

The main difference between system 600 and system 300 is instead of buffer 330, an inverter 630 is provided. Thus, this leads to an effect of every odd number being doubled by 2, while every even number is notched (thereby seeing the opposite effect caused by implementing system 300). Thus, by implementing a combination of system 300 and system 600, various different components may be effectively notched out.

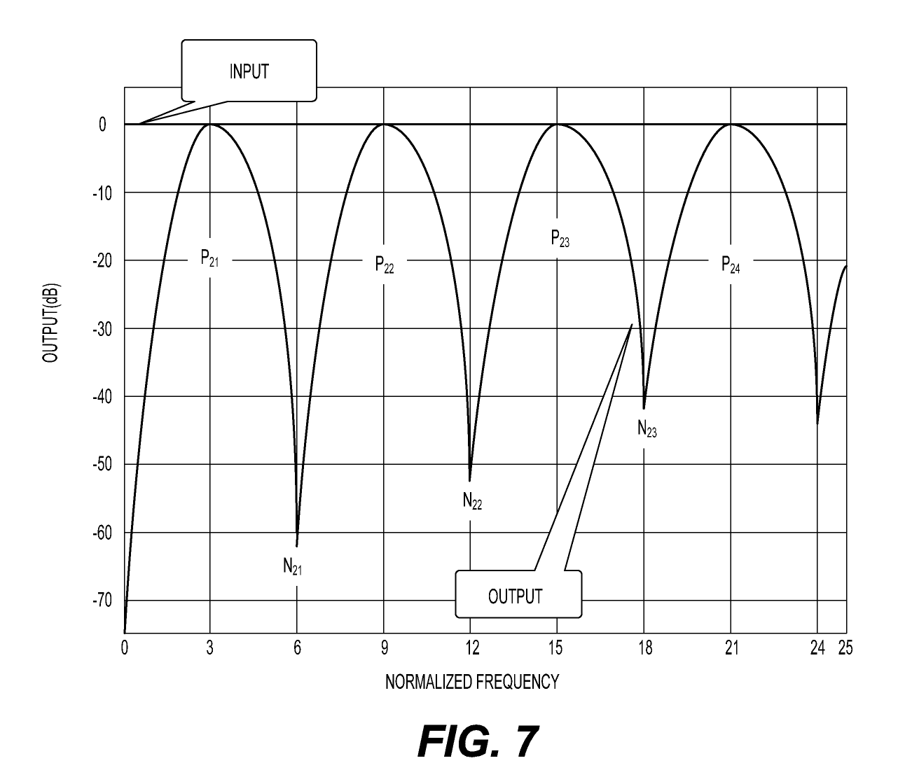

FIG. 7 illustrates a simulation depicting system 600 with a sample signal 110. As shown in FIG. 7, a low frequency spectrum (0 Hz DC) is notched (i.e. made close to 0 Db). This application may be especially pertinent to cases in which AM receivers experience power line interference.

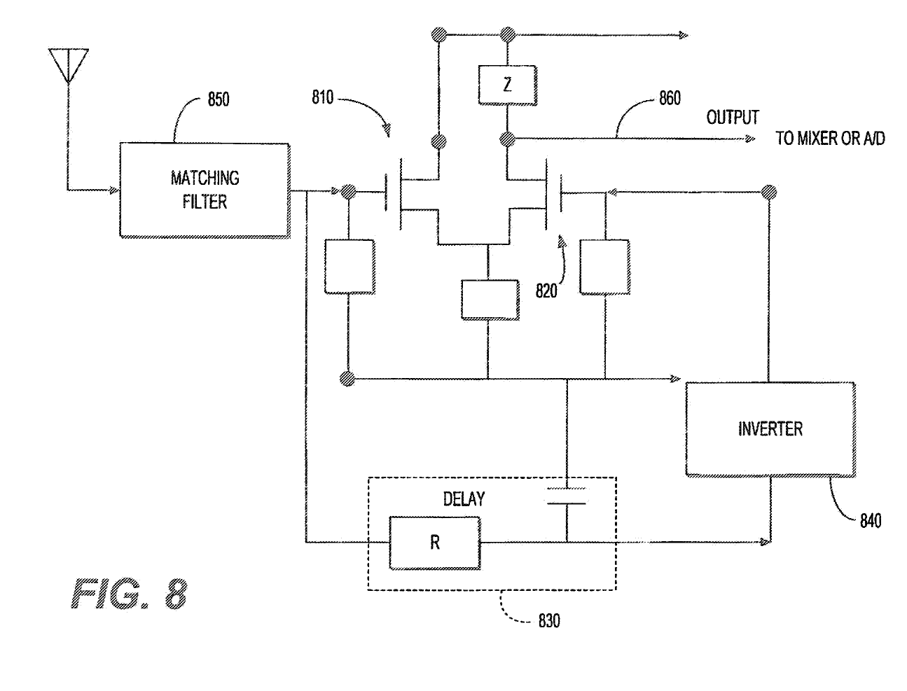

FIG. 8 illustrates a circuit diagram of an example multi-notch filter circuit 800 according to system 300.

The circuit 800 includes a first transistor 810 and a second transistor 820, a delay circuit 830, an inverter circuit 840. An input signal, such as input signal 110 drives the matching filter 850. The signal 110 is delayed by the delay circuit 830. The delay circuit 830 may be any combination of resistors or capacitors to generate an appropriate notching delay. The appropriate notching delay corresponds to frequencies that the implementer of the aspects disclosed herein desires to notch out. Certain interferences may be associated with various known or approximated frequencies (such as power lines, etc). The altering of the resistance and capacitance to form the appropriate notching delay is described below. The first transistor 810 and the second transistor 820 create a summing effect, and essentially sum the signal 110 with a delayed component of the signal 110. The summing, as realized at the output node 860 creates a notched signal according the output described with system 300.

Referring to FIG. 8, one example of a low noise amplifier is shown (with the combinations of transistors and other elements implemented). However, one of ordinary skill in the art may implement a multi-notch filter by employing analogous elements with the circuit elements shown in FIG. 8.

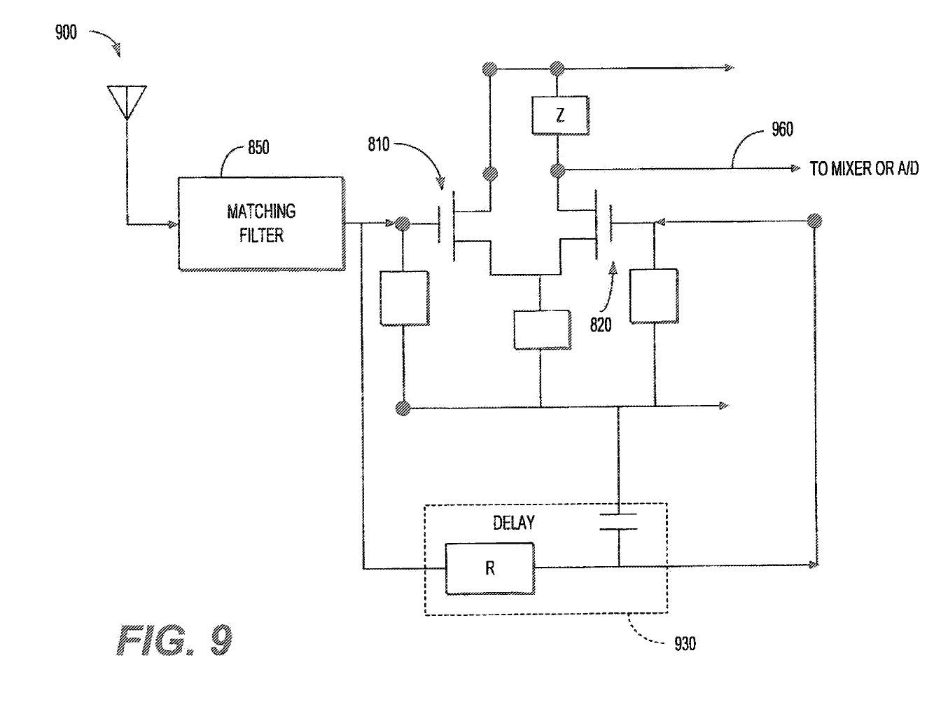

FIG. 9 illustrates a circuit diagram of an example multi-notch filter circuit 900 according to system 600. The circuit 900 is substantially similar to the circuit 800, except the inverter is now removed. Essentially, the circuit 900 may be employed to implement system 600. The resultant output 960 corresponds significantly to the output A(t) described above in regards to the system of FIG. 6,

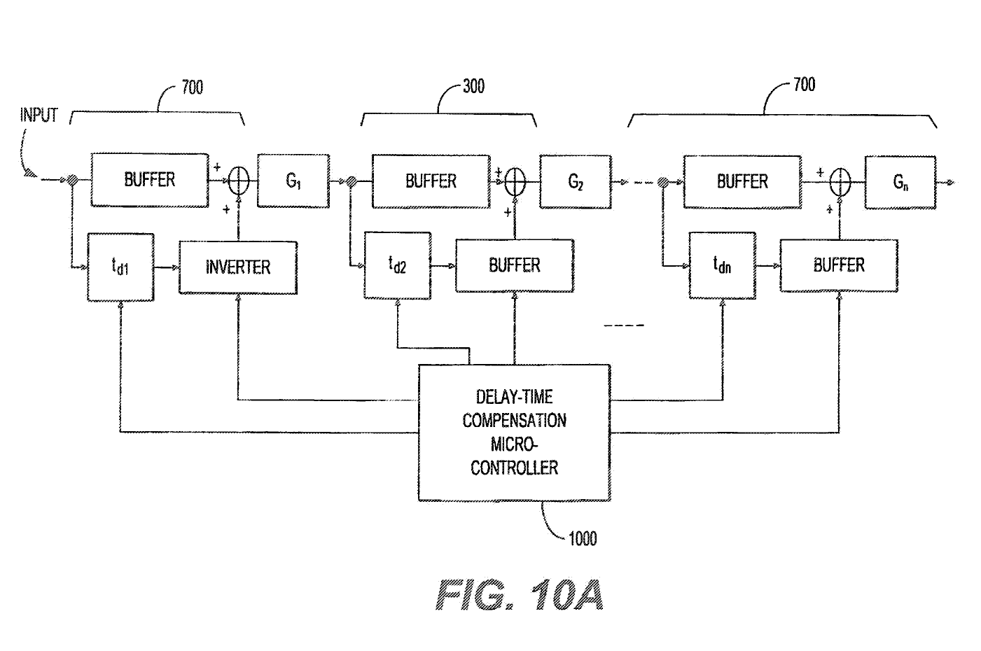

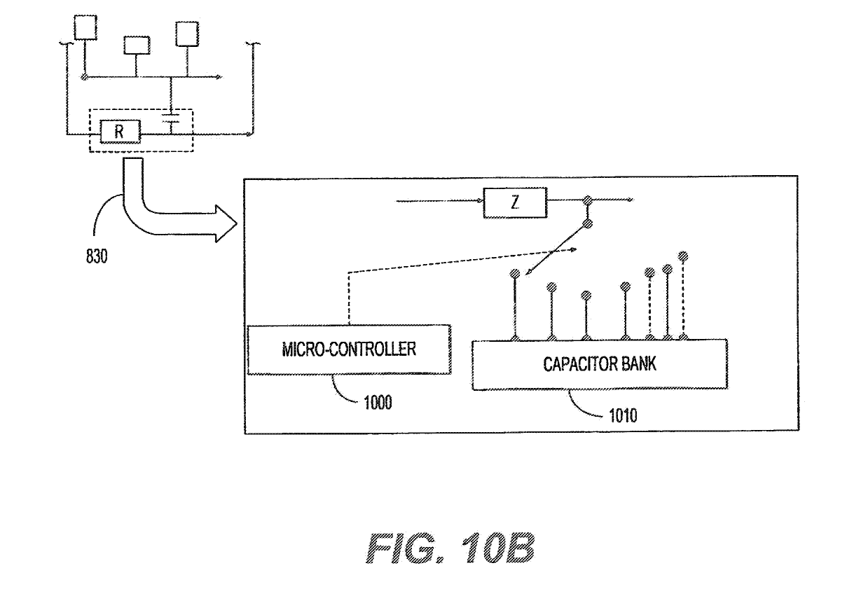

FIG. 10(a) illustrates an example implementation of several of system 300 and system 600 being cascaded together. Thus, depending on the frequencies that are desired to notch out, various combination of delays as applied to systems 300 and 600 may be implemented. FIG. 10(a) employs a delay-time compensation microcontroller 1000, which is described in further detail with regards to FIG. 10(b).

FIG. 10(b) illustrates an example implementation of the microcontroller 1000. The microcontroller 1000 takes various digital inputs, and adaptively sets the capacitor bank 1010 based on the digital input switches. The capacitor bank 1000 may be selectively altered based on the combination of digital inputs provided by the microcontroller 1000. Employing standard concepts associated with resistor/capacitor delay circuitry, an appropriate time delay may be set individually for every stated of a cascaded system shown in FIG. 10(a). Thus, depending on the frequencies to be notched out, various delays may be selected.

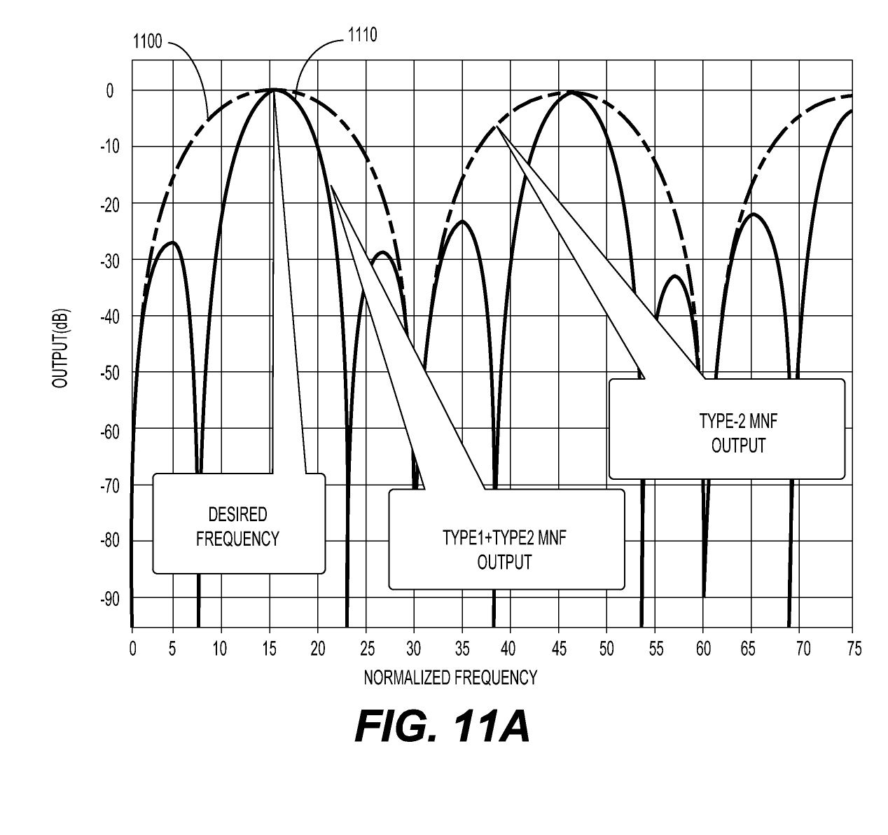

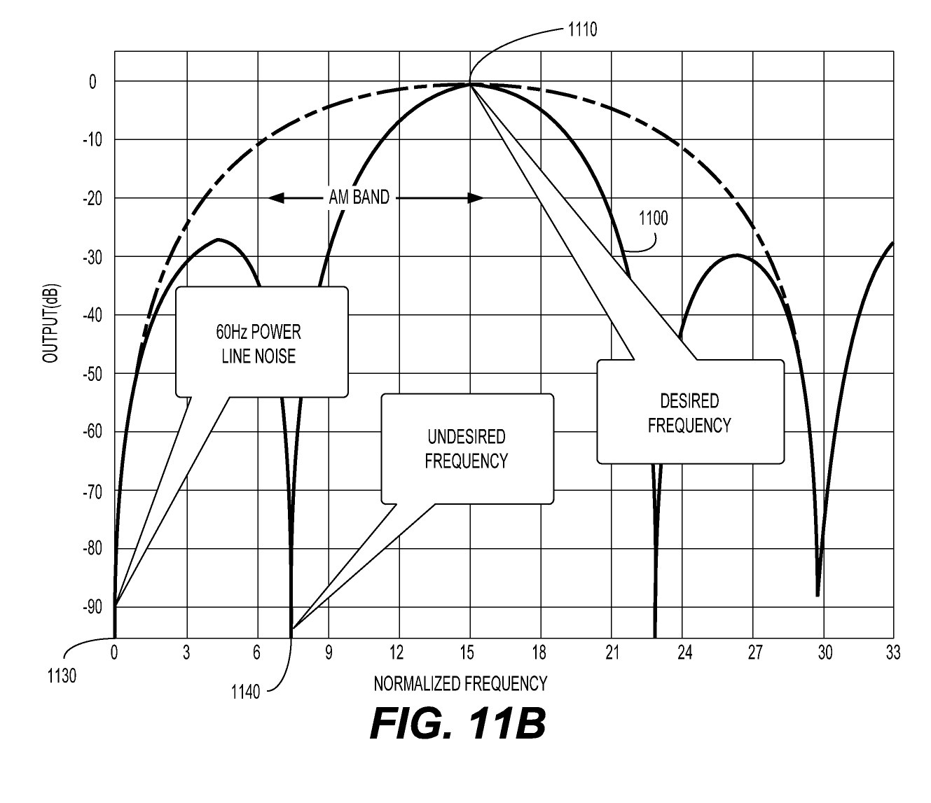

FIGS. 11(a) and 11(b) illustrate an example implementation of a combined multi-notch filter employing system 300 and system 600. As shown in FIGS. 11(a) and 11(b), a desired frequency crests at a certain level 1110, corresponding to the multi-notched signal 1100. Points 1130 and 1140 illustrate the portions of the signal 1100 that have been notched out. These points are specifically chosen to correspond to portions of the signal 1100 that experiences interference, such as power lines (point 1130) or undesired frequencies (1140). Thus, the elements that may cause interference may be effectively notched out of the signal, while the desired portion of the signal 1100 may be maintained and amplified (1110).

Thus, according to the aspects disclosed herein, and using the various multi-notch filter systems disclosed herein (300 and 600), various undesired interference signals may be removed. Further, due to the relative simple implementation of using a micro-controller to variably provide delay times for each multi-notch filter system, a cost-effective solution may be achieved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

The aspects disclosed herein may be implemented in many other signal processing applications, such as; audio signal processing, video signal processing, demodulation filters for OFDM (Orthogonal Frequency Division Multiplexing), and for optical filter applications.

We claim:

1. A system for multi-notch filtering for a communication device, comprising:
an input node to receive a signal directed to the communication device;
a time delay element to delay the signal by a predetermined time delay;
a summation element to sum the signal and the time-delayed signal; and
a gain element to output the summed signal to the communication device.

2. The system according to claim 1, further comprising:
a first buffer to buffer the signal prior to summation; and
a second buffer to buffer the time-delayed signal prior to summation.

3. The system according to claim 1, further comprising:
a second input node to receive the summed signal;
a second time delay element to delay the summed signal by a second predetermined time delay;
a second summation element to sum the summed signal and the time-delayed signal; and
a gain element to output the second summed signal to the communication device.

4. The system according to claim 1, further comprising an inverter element to invert the time-delayed signal prior to summation.

5. The system according to claim 3, further comprising a microcontroller circuit to control the predetermined and the second predetermined time delay.

6. The system according to claim 5, wherein the microcontroller controls the predetermined and the second predetermined time delays by setting a switchable capacitor bank.

7. The system according to claim 1, wherein the communication device is an AM receiving device.

8. The system according to claim 1, wherein the signal is interfered by one of at least: other broadcasts, lightning, power line noise, other car noises, or electrical motor noise.

9. The system according to claim 1, wherein the summation element is a low noise amplifier.

10. A method for multi-notch filtering for a communication device, comprising:
receiving a signal directed to the communication device;
delaying the signal by a predetermined time delay;
summing the signal and the times-delayed signal; and
outputting the summed signal to the communication device.

11. The method according to claim 10, further comprising:
buffering the signal prior to summation; and
buffering the time-delayed signal prior to summation.

12. The method according to claim 10, further comprising:
receiving the summed signal;
delaying the summed signal by a second predetermined time delay;
summing the summed signal and the time-delayed signal; and
outputting the second summed signal to the communication device.

13. The method according to claim 10, further comprising inverting the time-delayed signal prior to summation.

14. The method according to claim 13, further comprising a microcontroller circuit to control the predetermined and the second predetermined time delay.

15. The method according to claim 14, wherein the microcontroller controls the predetermined and the second predetermined time delays by setting a switchable capacitor bank.

16. The method according to claim 10, wherein the communication device is an AM receiving device.

17. The method according to claim 10, wherein the signal is interfered by one of at least: other broadcasts, lightning, power line noise, other car noises, or electrical motor noise.

18. The method according to claim 10, wherein the summing is performed by a low noise amplifier.
